(19) United States
(12) Patent Application Publication
(10) Pub. No.: US 2023/0373217 A1
(43) Pub. Date: Nov. 23, 2023

(54) COLLECTING WASTE PRINTING FLUID

(71) Applicant: Hewlett-Packard Development Company, L.P., Spring, TX (US)

(72) Inventors: Jeffrey L. THIELMAN, Sant Cugat del Valles (ES); Alejandro MIELGO BARBA, Sant Cugat del Valles (ES)

(73) Assignee: Hewlett-Packard Development Company, L.P., Spring, TX (US)

(21) Appl. No.: 18/248,152

(22) PCT Filed: Oct. 7, 2020
(86) PCT No.: PCT/US2020/054566

§ 371 Date: Apr. 6, 2023

(51) Int. Cl. B41J 2/165; B41J 2/17

(52) U.S. Cl. CPC B41J 2/16523; B41J 2/16508; B41J 2/1721; B41J 2002/1742

(57) ABSTRACT

It is herein disclosed a waste printing fluid collection unit that may be part of a servicing station and/or a printing system, the waste printing fluid collection unit comprising; a collection reservoir for collecting the waste printing fluid, the collection reservoir having an end wall that separates the collection reservoir from ambient air; and a wick extending from the end wall towards the reservoir; wherein the wick is on a first side, connected to the end wall and, on a second side extends into the reservoir to contact the waste printing fluid.

### BACKGROUND

Due to the print nature in industrial environments, some printing systems may have a substantial amount of waste printing fluid that is produced by the printer during a printing operation. In smaller printing systems, this waste printing fluid can be managed with a disposable absorber, commonly called a diaper. In larger or higher volume printing systems, the fluid amount is greater and a waste collecting mechanism must be employed. Examples of such mechanisms include a bottle or other container as a collection reservoir to accumulate and store the waste printing fluid.

Determining when the waste reservoir is full and needs replacing and/or cleaning is a feature to be considered. If servicing is deferred too long, the reservoir can overflow and cause damage to the printing system, ruin the customer prints, stain the store or site where the system is installed and even generate environmental hazards. Servicing too soon costs extra time and money, wastes resources and causes additional down time for the printer thereby reducing overall productivity.

### BRIEF DESCRIPTION OF THE DRAWINGS

FIG. 1 shows an example of a servicing station that may be part of a printing system.

FIG. 2 shows a cross section of a servicing station wherein a waste collection unit is shown in detail.

FIG. 3 shows a perspective view of a printing system and its interaction with a servicing station according to an example.

FIG. 4 shows a simplified perspective view of the printing system of FIG. 3.

FIG. 5 shows a longitudinal section of an example of a servicing station including a waste collection unit and a servicing unit.

### DETAILED DESCRIPTION

A mechanism for collecting waste printing fluid such as an ink or a non-marking fluid in a printer is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In varying examples, the waste printing fluid collection unit utilizes a capillarity element within the waste collection unit as to enhance the evaporation of the printing fluid thereby increasing the maintenance cycles for the waste printing fluid collection unit.

In this context, the present disclosure refers to a waste printing fluid collection unit comprising;
a collection reservoir for collecting the waste printing fluid, the collection reservoir having an end wall that separates the collection reservoir from ambient air, and
   a wick extending from the end wall towards the reservoir;
wherein the wick is on a first side, connected to the end wall and, on a second side extends into the reservoir to contact the waste printing fluid.

In an example, part of the first side of the wick extends through the end wall, thereby being exposed to ambient air.

The waste printing fluid collection unit of claim 1 wherein the waste printing fluid connection unit is to couple to a servicing unit that includes a printhead cleaning mechanism.

Furthermore, the waste printing fluid collection unit may, for example, include an opening to allow ambient air into the collection reservoir. Such opening may be in the form of holes that allow for ambient air to enter into the collection reservoir or a slot in a determined position for such a purpose. In a particular example, the waste printing fluid collection unit comprises a plurality of openings to allow ambient air into the collection reservoir

Since the servicing waste printing fluid collection unit is part of a movable mechanism that may move or contact a device that moves, the reservoir may comprise a series of anti-slosh baffles defining a plurality of fluid chambers as to prevent waste printing fluid to spill and improve the stability of the collection unit.

In a further example, the wick extends from the end wall towards one of the fluid chambers.

As for the material of the wick, such a wick may comprise a bi-component fiber.

Also, it is herewith disclosed a printing system comprising a servicing station and a print engine the printing system having reciprocating movement capability between the print engine and the servicing station, wherein the servicing station comprises a waste printing fluid collection unit, the waste printing fluid collection unit having:
a collection reservoir having an inner volume for collecting waste printing fluid; and
a wick extending within the inner volume; wherein the wick extends from an upper portion of the collection reservoir towards a lower portion of the collection reservoir.

In an example, as mentioned above, the wick comprises a bi-component fiber. Also, in a further example, the bi-component fiber forms a tortuous fluid path along the wick.

In a particular, example, the waste printing fluid collection unit comprises an opening to allow ambient air into the collection reservoir.

Moreover, the present disclosure refers to a servicing station for a printing system wherein the servicing station comprises:
a waste collection unit comprising a collection reservoir; and
servicing mechanisms for performing servicing operations on a printhead;
   wherein the printing system is to position the printhead over the waste collection unit or over the servicing mechanisms and wherein the waste collection unit comprises a wick extending through the collection reservoir for enhancing evaporation of waste printing fluid.

In an example, the wick extends from an upper portion of the collection reservoir to a lower portion of the collection reservoir. In a further example, the wick comprises a bi-component fiber.

In the following description and figures, some example implementations of print apparatus, print systems, and/or methods of printing are described. In examples described herein, a “printing system” may be a system to print content on a physical medium (e.g., paper, textiles, a layer of powder-based build material, etc.) with a printing fluid material (e.g., inks, pretreatments or enhancers). For example, the printing system may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A printing system may utilize suitable print consumables, such as ink, toner, fluids or powders, or other raw materials for printing. In some examples, the printing system may be a three-dimensional (3D) printer. An example of fluid print material or printing fluid is a water-based latex ink ejectable from a print head, such as a piezoelectric print head or a thermal inkjet print head. Other examples of printing fluid may include dye-based color inks, pigment-based inks, solvents, gloss enhancers, fixer agents, and the like.

Inkjet printing systems are, in general terms, controllable fluid ejection devices that propel droplets of printing fluid from a nozzle to form an image on a substrate wherein such propelling can be achieved by different technologies such as, e.g., thermal injection or piezo injection.

In some inkjet printing systems, waste printing fluid that accumulates as a result of, for example, overspray due to inaccuracies and tolerances of producing a full (or partial) bleed print, purging of nozzles, servicing of nozzles, and aerosol from the printing fluid deposition process itself is collected in a service station 1. In an example, a service station 1 may comprise two units: a servicing unit 11, and a waste collection unit 12.

The servicing unit 11, is an unit wherein several servicing mechanisms to actively perform a servicing operation on nozzles of a printing system such as, for example: a capping unit 110 to cap the nozzles thereby preventing air from contacting printing fluid within the nozzles thereby reducing the risk of crusting; or wipers 111 that may be to actively scrap the outer surface of the nozzles to remove crusting or other artifacts within the outer surface of the printheads.

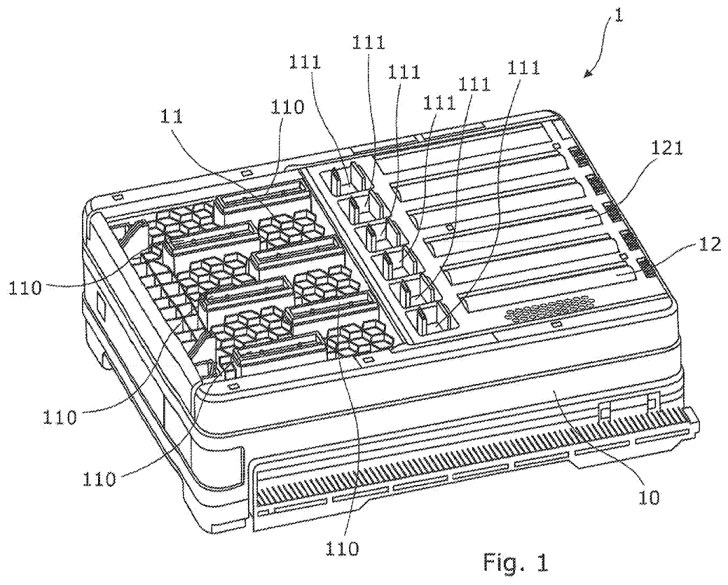

The waste collection unit 12 comprises passive elements that are to receive waste printing fluid that arises as part of a servicing operation carried out by elements external to the service station 1 such as spitting for servicing purposes (i.e., using the thermal or piezoelectric actuators of a printing operation), priming (using air at a determined pressure to force the ejection of printing fluid) or, even to receive shipping fluid that is normally shipped with new printheads and that is to be disposed before the first printing operation. Such waste printing fluid may, be stored in a waste printing fluid collection unit 12 after the servicing operation is performed. In an example, during a maintenance operation, a printer ejects waste printing fluid, for example, to clean the nozzles. Such waste printing fluid is ejected over the waste printing fluid collection unit 12 over a determined element such as a spit plate, an absorbent element or, as shown in FIG. 1, over spit rollers 121 wherein waste printing fluid flows to a waste printing fluid collection reservoir 10.

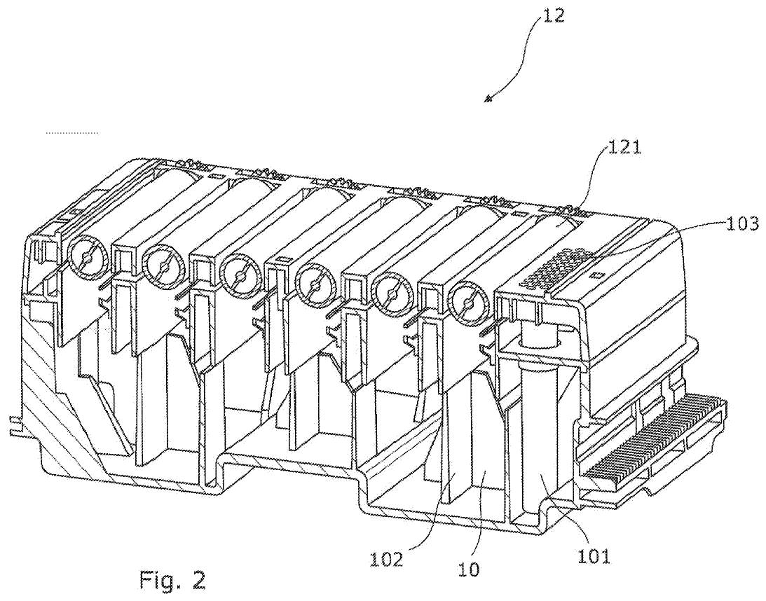

FIG. 2 shows a cross-section of an example of a service station showing the waste printing fluid collection unit 12. In the example of FIG. 2, the spit rollers 121 are to receive waste printing fluid from a printing system, having spit rollers 121 that sit close to the printhead at a similar distance as the printing media, which reduces aerosol compared with spitting over foams at a greater distance. In any case, some printing system comprise spit plates or inclined surfaces instead of the spit rollers and, in a further example, waste printing fluid collection unit 12 may lack spit rollers or spit plates and simply have a fluid path towards a waste printing fluid collection reservoir 10.

Further, as can be seen in FIG. 2, the waste printing fluid collection reservoir 10 may comprise a series of anti-slosh baffles 102 that are basically walls that define a plurality of chambers defining labyrinthic path for the fluid contained in the reservoir 10 to prevent spillages and increase the stability due to the relative movement between the service station and a printhead.

Also, the waste collection unit 12 comprises a wick 10 that extends from an end wall into the waste printing fluid collection reservoir 10. The wick 101 is to contact waste printing fluid within the waste printing fluid collection reservoir 10 and enhance the evaporation of such waste printing fluid thereby increasing the lifetime of the waste printing fluid collection reservoir as more waste printing fluid may be received until a maintenance operation (cleaning, replacing, etc.) is recommended.

In the context of the present invention, a wick is to be understood as an element that, by capillarity, absorbs or drains waste printing fluid, for example, from a bottom surface wherein waste printing fluid is mostly accumulated towards another portion of the waste collection reservoir 10. In an example, the wick allows for waste printing fluid to travel in opposition to gravity from a lower portion of the waste printing fluid collection reservoir 10 to an upper portion of such reservoir.

The waste collection unit 12 may also comprise an exhaust 103, in an example, the exhaust 103 comprises an aperture that allows for the wick 101 to have some contact with ambient air. In an example, the wick may extend through a wall of the waste printing fluid collection reservoir 10 thereby being exposed to ambient air. In a further example, as shown in FIG. 2, the exhaust 103 comprises a plurality of apertures that allow for the entry of ambient air into the waste printing fluid reservoir 10 and, in consequence, contact with the wick 101. Such an example allows for having an enhanced evaporation of the printing fluid within the waste printing fluid reservoir given that the presence of the wick increases the surface area per volume of printing fluid and the presence of the exhaust reduces the air saturation inside the waste printing fluid reservoir 10, being both of such factors influential on the evaporation process.

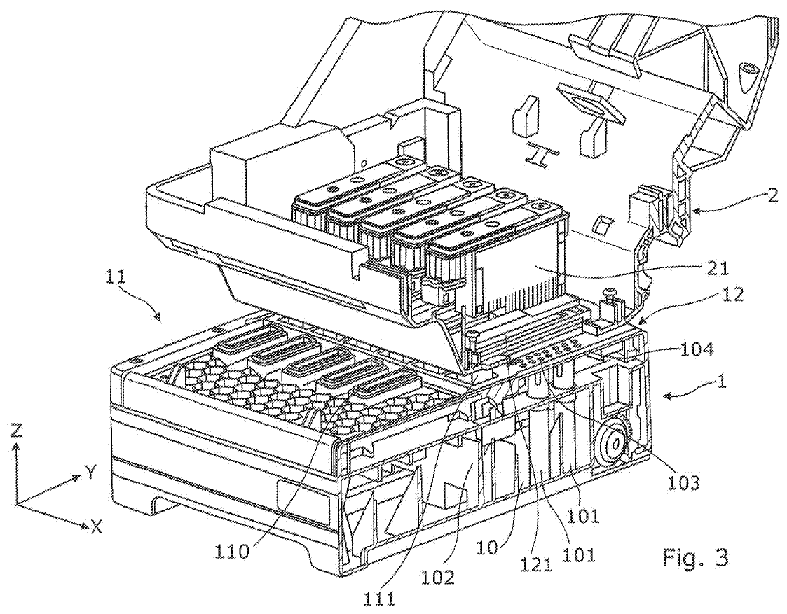

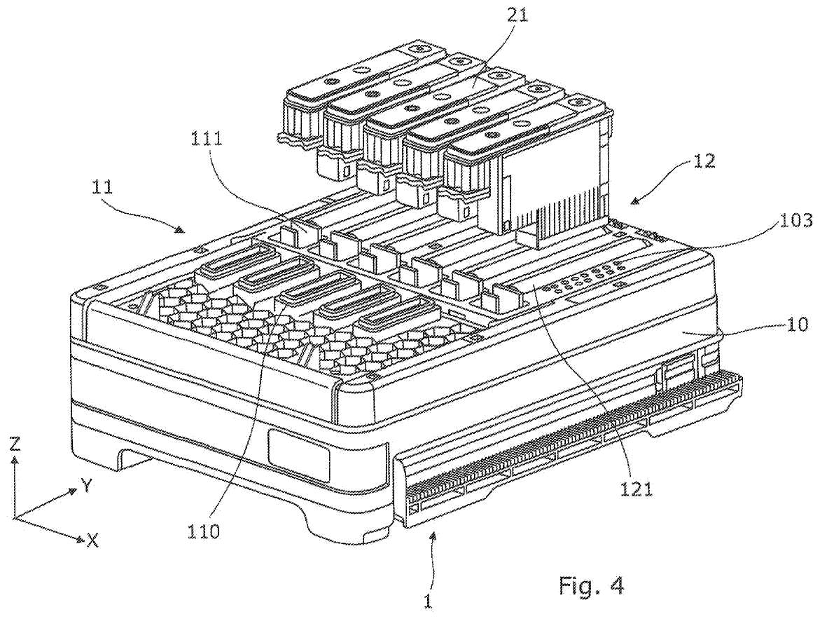

FIGS. 3 and 4 show an example of a printing system including a servicing station 1 according to an example. FIG. 3 shows a carriage assembly 2 having a plurality of printheads 21, wherein the carriage assembly 2 is to move along a scanning direction corresponding to the X axis of the figure depositing printing fluid onto a substrate for a printing operation.

In FIG. 3, the carriage 2 is positioned on a servicing location, e.g., at an edge of the scanning direction for performing a servicing operation such as active servicing by a servicing unit 11 or passive servicing by a waste collection unit 12. FIG. 4 shows a view removing the carriage 2 to show in better detail the relative positioning between the printheads 21 and the service station 1 while the printheads and the servicing station are in a passive servicing operation.

Upon determination that a passive servicing operation is to be performed on the printheads 21 the carriage moves to the servicing location and the servicing station 2 may reciprocate along a servicing direction that corresponds with the Y-axis of FIG. 3 so that the printheads 21 are aligned with a position within the servicing station 1 wherein printing fluid ejection may be performed for servicing purposes, e.g. by spitting or priming the printheads. In the present case, the servicing station 1 is positioned so that the printheads 21 are aligned with the spit rollers 121, i.e., so that the printing fluid collection unit 12 is aligned with the printheads 21.

On the other hand, if active servicing is to be performed, the servicing unit may move along the servicing direction so that the servicing unit 11 is aligned with the printheads 21. Then, the carriage or the servicing unit may reciprocate along the scanning direction to have a wiping action performed by the wipers 111 or the printheads 21 may be positioned over their respective caps 110. Alternatively, other servicing mechanisms such as blades may be used on the servicing unit 11.

Since the servicing station 1 is subject to movements along different directions such as a movement along the service direction and possibly along the scanning direction, anti-slosh elements are beneficial to include in the waste printing fluid reservoir 110, for that purpose, the waste printing fluid collection unit 11 comprises a series of baffles 102 that are essentially walls or grids that interfere with the movement of the printing fluid as to reduce the travel speed of the waste printing fluid and, in consequence, its effect on the energy required for moving/stopping the servicing unit 1 and, also, to prevent possible spillages of waste printing fluid.

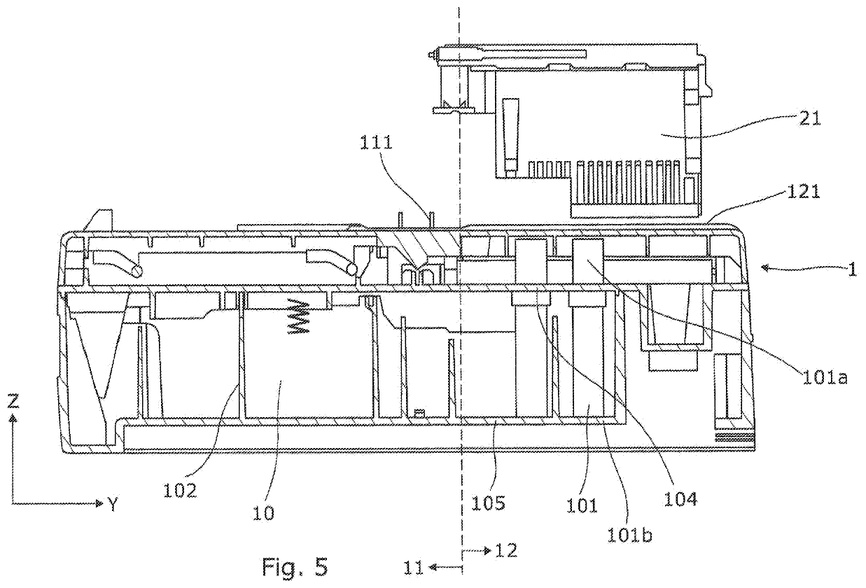

FIG. 5 shows a longitudinal section (along the Y-axis) of a service station 1 and a printhead positioned in a passive servicing operation position.

In the example of FIG. 5 it is shown, as in previous examples, that the servicing station 1 is a two-part servicing station 1 comprising a servicing unit 11 for active servicing a waste collection unit 12 for passive servicing. However, examples of servicing stations 1 according to the present disclosure may lack a servicing unit 11 and still comprise the waste collection unit 12.

Focusing on the waste collection unit 12, such unit may comprise a plurality of wicks 101, in the example of FIG. 5 two wicks 101 are provided, further wicks may be added depending on the structure and/or capacity of the waste printing fluid reservoir 10 and depending on the rate of desired evaporation. In the example shown in FIG. 5 the wicks 101 extend from an end wall of the waste printing fluid collection reservoir 10, in particular, from the top wall 104 and extend into the reservoir 10, in particular, down to the bottom surface of the reservoir. As shown in FIG. 5, a first side 101a of the wick is connected or passes through the top wall 104 while a second side 101b of the wick is within the reservoir 10 exposed to contact with waste printing fluid.

For evaporation to be enhanced, at least a portion of the wick may be in contact with ambient air. In an example, the first side 101a of the wick may be placed so that it is in contact with ambient air whereas the second side may be sealed within the waste printing fluid collection reservoir 10.

In other examples, an exhaust may be provided to allow air also inside the waste printing fluid collection reservoir 10. Such examples allow fresh air (i.e., air which is neither already saturated with vapors from the waste printing fluid nor with other substances) to move along the wick, then the concentration of the evaporated waste printing fluid in the air is less likely to increase with time, thus encouraging a faster evaporation.

As for the wick 101, an example material that may be used is a porous composite having fibrous bands such as a bi-component fiber wick, e.g., a wick comprising a fluid transmissive body formed from a bicomponent fibers bonded to each other and defining tortuous fluid flow paths through the fluid transmissive body. In an example the wick is a porous element thereby allowing air/waste printing fluid exchange and allowing the evaporation of such printing fluid.

The use of bi-component fibers allows for an increased performance on waste printing fluid comprising small particles such as pigments as they are less prone to clogging.

Without further analysis, the foregoing so fully reveals the gist of the present inventive concepts that others can, by applying current knowledge, readily adapt it for various applications without omitting features that, from the standpoint of prior art, fairly constitute the characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A waste printing fluid collection unit comprising;
a collection reservoir for collecting the waste printing fluid, the collection reservoir having an end wall that separates the collection reservoir from ambient air; and
a wick extending from the end wall towards the reservoir;
wherein the wick is on a first side, connected to the end wall and, on a second side extends into the reservoir to contact the waste printing fluid.

2. The waste printing fluid collection unit of claim 1 wherein part of the first side of the wick extends through the end wall, thereby being exposed to ambient air.

3. The waste printing fluid collection unit of claim 1 wherein the waste printing fluid connection unit is to couple to a servicing unit that includes a printhead cleaning mechanism.

4. The waste printing fluid collection unit of claim 1 wherein the waste printing fluid collection unit comprises an opening to allow ambient air into the collection reservoir.

5. The waste printing fluid collection unit of claim 4 wherein the waste printing fluid collection unit comprises a plurality of openings to allow ambient air into the collection reservoir

6. The waste printing fluid collection unit of claim 1 wherein the reservoir comprises a series of anti-slosh baffles defining a plurality of fluid chambers.

7. The waste printing fluid collection unit of claim 6 wherein the wick extends from the end wall towards one of the fluid chambers.

8. The waste printing fluid collection unit of claim 6 wherein the wick comprises a bi-component fiber.

9. A printing system comprising a servicing station and a print engine the printing system having reciprocating movement capability between the print engine and the servicing station, wherein the servicing station comprises a waste printing fluid collection unit, the waste printing fluid collection unit having:
a collection reservoir having an inner volume for collecting waste printing fluid; and
a wick extending within the inner volume;
wherein the wick extends from an upper portion of the collection reservoir towards a lower portion of the collection reservoir.

10. The printing system of claim 9 wherein the wick comprises a bi-component fiber.

11. The printing system of claim 9 wherein the bi-component fiber forms a tortuous fluid path along the wick.

12. The printing system of claim 9 wherein the waste printing fluid collection unit comprises an opening to allow ambient air into the collection reservoir.

13. Servicing station for a printing system wherein the servicing station comprises:
a waste collection unit comprising a collection reservoir; and
servicing mechanisms for performing servicing operations on a printhead;
wherein the printing system is to position the printhead over the waste collection unit or over the servicing mechanisms and wherein the waste collection unit comprises a wick extending through the collection reservoir for enhancing evaporation of waste printing fluid.

14. The servicing station of claim 13, wherein the wick extends from an upper portion of the collection reservoir to a lower portion of the collection reservoir.

15. The servicing station of claim 13 wherein the wick comprises a bi-component fiber.
